(19) United States
(12) Patent Application Publication
(10) Pub. No.: US 2006/0020503 A1
(43) Pub. Date: Jan. 26, 2006

(54) Systems and methods for tracking employee job performance

(76) Inventors: John F. Harris, Alpharette, GA (US); Piotr Horbulewicz, Lawrenceville, GA (US); Jane B. Nowak, Marietta, GA (US); Leonid Volozhanin, Lilburn, GA (US); Tim Walters, Chattanooga, TN (US)

Correspondence Address: LEE & HAYES, PLLC, 421 W. RIVERSIDE AVE., SUITE 500, SPOKANE, WA, 99201, US

(21) Appl. No.: 10/819,508

(22) Filed: Apr. 7, 2004

(51) Int. Cl. G06Q 90/00

(52) U.S. Cl. 705/11

(57) ABSTRACT

Systems and methods for tracking employee job performance include receiving performance-related data from an employee. The performance-related data may include a schedule from the employee, a number of a demand activity performed by the employee, and a type of the demand activity performed by the employee. Systems and methods for tracking employee job performance also may include calculating a statistic related to the job performance of the employee and generating a report detailing the job performance of the employee. The report may be generated over a managerial scope received from a management user and may include the statistic related to job performance.

### TECHNICAL FIELD

The present invention relates generally to systems and methods for collecting, analyzing, and reporting data and, more particularly, to systems and methods for tracking employee job performance.

### BACKGROUND

For many employers, there is a need to track employees in the performance of their daily tasks. For example, detailed knowledge of how employees use time spent at work and the tasks that they accomplish at work may allow employers to identify and minimize factors that are harmful to productivity.

Existing methods of tracking employee job performance require employees to keep track of hours worked, tasks completed, and other performance-related data on paper forms. The forms are then analyzed by hand, or entered into a computing system and analyzed using a software package, such as, for example, Microsoft Excel®. Both of these options are very labor intensive. Hand analysis requires significant time from employees skilled in analysis. Also, computer analysis requires significant data entry time.

Accordingly, enhanced systems and methods for tracking employee job performance are needed to record and manage the daily work of employees.

### SUMMARY

In one general aspect, employee job performance may be tracked by a desktop client module for receiving performance-related data from an employee. The performance-related data may include a schedule from the employee, a number of instances of a demand activity performed by the employee, and a type of the demand activity performed by the employee. Employee job performance also may be tracked by a processing module for calculating a statistic related to the job performance of the employee. A report module may generate a report detailing the job performance of the employee. The report may be generated over a managerial scope received from a management user and include one or more statistics related to the job performance of the employee.

In another general aspect, employee job performance may be tracked by receiving performance-related data from an employee, calculating a statistic related to the job performance of the employee, and generating a report detailing the job performance of the employee. The report may be generated over a managerial scope received from a management user and include one or more statistics related to job performance. The performance-related data may include a schedule from the employee, a number of a demand activity performed by the employee, and a type of the demand activity performed by the employee.

Implementations may include one or more of the following features. For example, a system may include a management module for providing a user with access to the functionality of the system. A list of demand activities may be provided to an employee, who may select a demand activity from the list. Also, the report may contain a graphical representation of the statistic related to the job performance of the employee.

Aspects of the present invention may be implemented by a computer system and/or by a computer program stored on a computer readable medium. The computer readable medium may comprise a disk, a device, and/or a propagated signal.

Other features and advantages will be apparent from the following description, including the drawings, and from the claims.

### DESCRIPTION OF THE FIGURES

FIG. 1 illustrates a communications system for tracking employee job performance according to one embodiment of the present invention.

FIG. 2 is a flowchart of a method for tracking employee job performance according to one embodiment of the present invention.

FIGS. 3A-3D, 4A-4I, and 5A-5M are graphical user interfaces according to one embodiment of the present invention.

### DETAILED DESCRIPTION

In one general aspect, the present invention is directed to systems and methods for tracking employee job performance. For simplicity, the basic components of such systems and methods are provided. However, as would be understood by one of ordinary skill in the art, the systems and methods described below may include various other structures and/or processes in actual implementation consistent with aspects of the present invention.

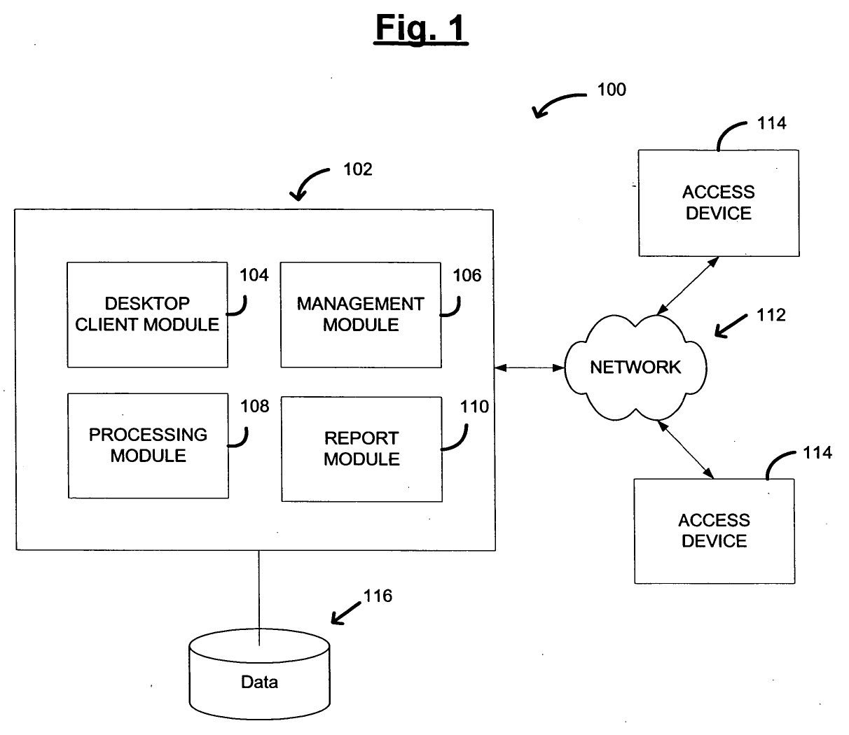

FIG. 1 shows a diagram of a network 100 including a system 102 for tracking employee job performance according to various embodiments. The modules 104-110 of the system 102 may collect data relating to employee performance and analyze the data to provide one or more reports of employee performance. The data may be collected, and the reports communicated to users of the system 102 through one or more access devices 114 via a network 112. The access devices 114 may be any type of devices capable of communicating with the system 102 via the network 112. For example, the access devices 114 may be computer devices (such as PC's, laptops, PDA's, pocket PC's, etc.) having browser software. The network 112 may be any type of data communications network, including, for example, the Internet and/or an intranet.

The system 102 may be implemented as one or a number of centrally and/or remotely located networked computer devices (e.g., a server) and may include modules 104-110, as described below. The modules 104-110 may be implemented as software code to be executed by a processor (not shown) of the system 102, and/or by one or more elements of the network 100, using any suitable computer language, such as, for example, Java, C, C++, or Perl using, for example, conventional or object-oriented techniques. The software code may be stored as a series of instructions or commands on a computer-readable medium, such as a random access memory (RAM), a read-only memory (ROM), a magnetic medium such as a hard drive or a floppy disk, or an optical medium, such as a CD-ROM.

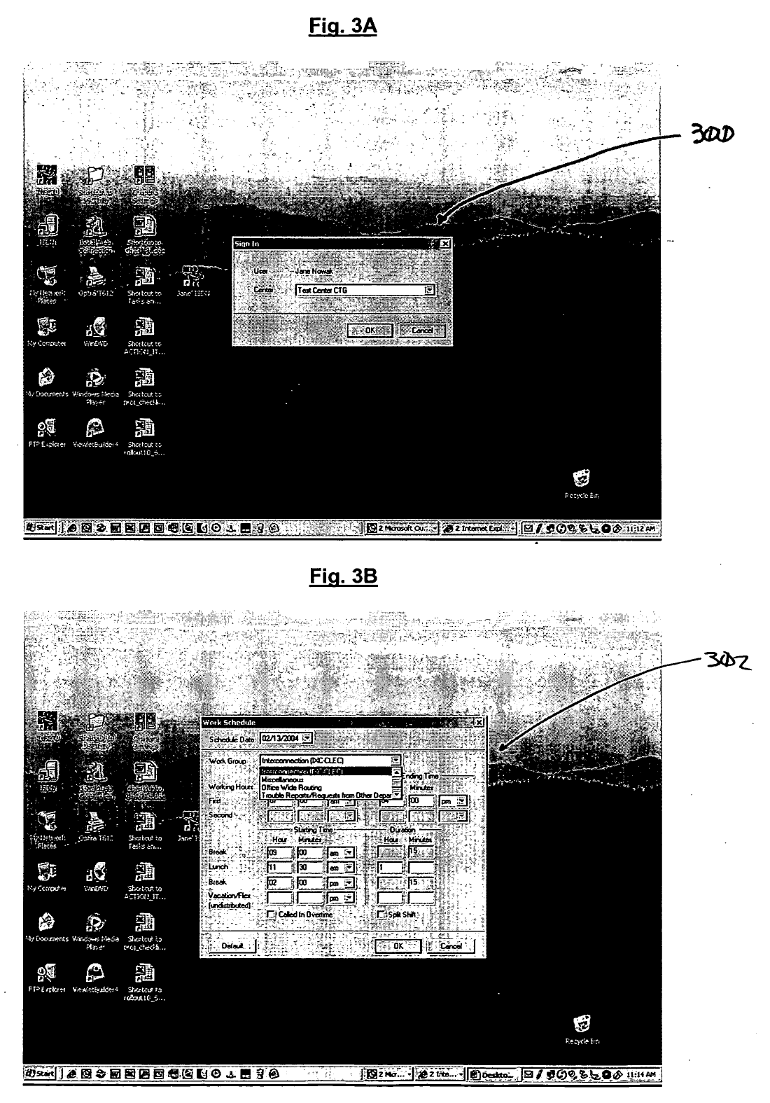

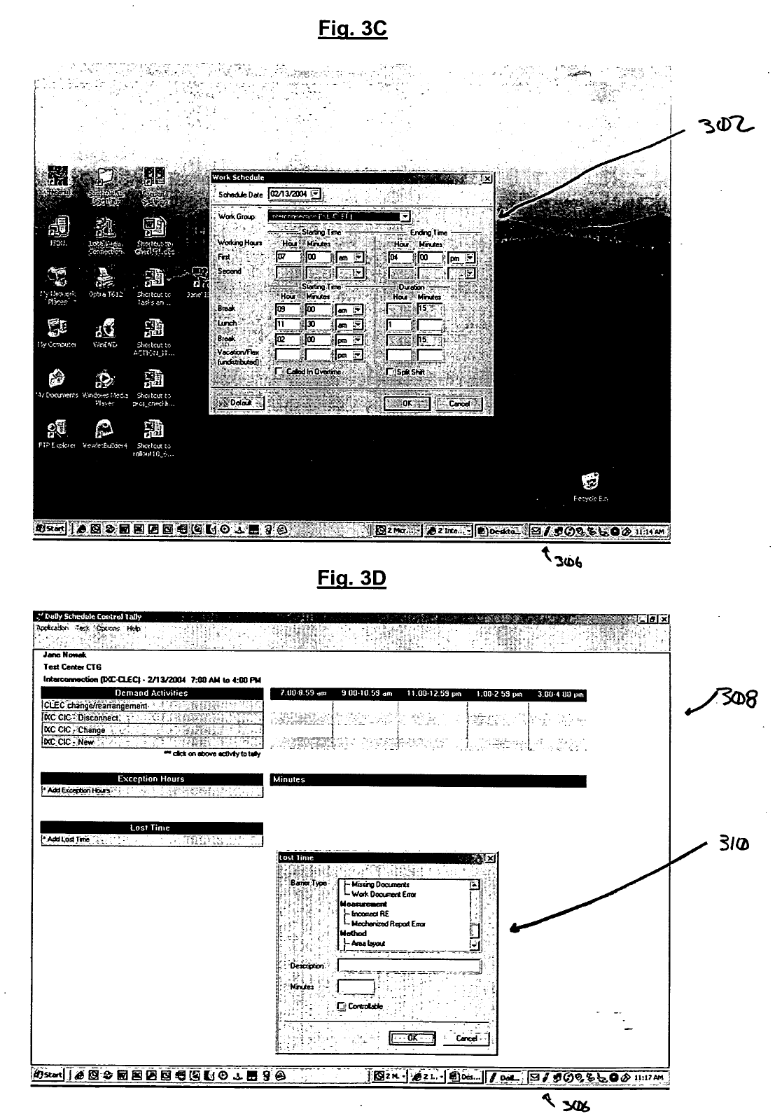

According to various embodiments, the modules 104-110 of the system 102 may present a user of the system with a set of user interface screens (UIs). One embodiment of a set of UIs that may be presented to a user of the network 100 according to aspects of the present invention is illustrated in FIGS. 3A-5M. In general, the UIs may be presented through an interactive computer screen to solicit information from and present information to a user in conjunction with a method for tracking employee job performance. In one implementation, the UIs may be presented through access devices 114, including personal computers running browser applications and having various input/output devices (e.g., keyboard, mouse, touch screen, etc.) for receiving user input.

A database 116 may be used to store data received or manipulated by the modules 104-110 of the system 102. The database may, according to various embodiments, include integrity mechanisms. For example, various tables of the database 116 may be linked to ensure that data manipulated by one of the modules 104-110 is not corrupted by another module. Also, records in the database may be assigned primary keys to allow particular modules 104-110 to access the same record.

The system 102 may, in various embodiments, be accessed by two main classes of users, employees, who may be referred to as craftspeople, and management users. Employees, or craftspeople, may make up the largest group of system 102 users, and may access the system 102 to enter data related to their own job performance, such as, for example, hours worked and demand activities completed. Management users may access the system 102 to edit or supplement data entered by craftspeople, as well as to view reports and analysis of employee job performance. Management users may have direct and/or indirect responsibility for supervising craftspeople. Also, there may be multiple classes of management users, each with different access to the system 102, as discussed in more detail below. It will be appreciated that although the system 102 may be used to directly track the job performance of craftspeople, the job performance of management users may be tracked by viewing the performance of the craftspeople under their direction.

According to various embodiments, craftspeople may access the system 102 primarily through a desktop client module 104. A craftsperson may sign into the desktop client module 104, for example, at the beginning of each shift and use its functionality to record time spent at work and details of how that time was spent.

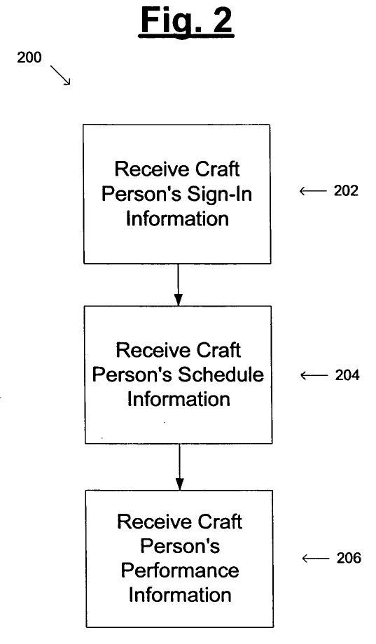

FIG. 2 is a flowchart of one embodiment of a process flow 200. The process flow 200 may represent an interaction between the desktop client module 104 and a typical craftsperson over the course of an exemplary shift. The functions of the process flow 200 may be executed by, for example, a processor of the system 102. In various embodiments, however, the functions or portions of the functions may be executed by a processor of an access device 114.

At step 202, the desktop client module 104 may receive sign-in information from a craftsperson. FIG. 3A illustrates one embodiment of a sign-in UI screen 300 that may be presented to a craftsperson. Sign-in information may include, for example: the craftsperson's name and the craftsperson's center. A craftsperson's center may represent the physical location where the craftsperson works, and may be selected from a drop down menu as shown in sign-in UI screen 300.

At step 204, the desktop client module 104 may receive the craftsperson's schedule information. FIGS. 3B and 3C illustrate one embodiment of a work schedule UI screen 302 that may be presented to a craftsperson. Receiving a craftsperson's schedule information generally may involve receiving the schedule that the craftsperson intends to work during a shift and receiving the craftsperson's work group.

The craftsperson's schedule for the shift may be entered into work schedule UI screen 302 as depicted in FIG. 3C. According to various embodiments, the desktop client module 104 and work schedule UI screen 302 may provide a default schedule to a craftsperson based on the craftsperson's center, work group, or previously entered schedules. If no default is provided, or if changes to the default must be made, the craftsperson may enter their schedule into the work schedule UI screen 302.

The work schedule UI screen 302 may contain various fields for entering a craftsperson's schedule. A set of fields may be for entering a starting time and an ending time for one or more daily shifts. The craftsperson may enter a second daily shift if the craftsperson plans to work a split shift, and/or if the craftsperson has been called in for overtime. The craftsperson may indicate that they are working a split shift, or have been called in for overtime by checking the appropriate box or boxes in the work schedule UI screen 302. The work schedule UI screen 302 also may contain a series of fields for recording the time and duration of the craftsperson's breaks and lunch periods. After entering a schedule, the craftsperson may click the “OK” button, which may cause the work schedule UI screen 302 to close.

The craftsperson may select his or her work group from a set of work groups displayed in a drop down menu as illustrated in UI screen 302, shown in FIG. 3B. The craftsperson may belong to a work group comprising other craftspeople who perform similar tasks. According to various embodiments, craftspeople of the same work group may perform and tally the same demand activities.

At step 206, the desktop client module 104 may receive performance data from the craftsperson. FIG. 3D illustrates one embodiment of a tally UI screen 308 that may be presented to a craftsperson. Performance data may include, for example: the number of times the craftsperson performed particular demand activities as well as a craftsperson's entries of exception hours and lost time. Demand activities may be productive tasks performed by a craftsperson. Exception hours may include time that the craftsperson spent performing work-related activities other than demand activities. For example, time that a craftsperson spent in training and in meetings may be included in exception hours. Identified lost time may be time that the craftsperson is unable to perform demand activities because of an external impediment. For example, if a craftsperson is unable to perform demand activities because of an equipment malfunction, time spent waiting for the repair may be lost time.

The tally UI screen 308 may include a series of buttons listed under the heading, “Demand Activities.” Each button may represent a particular demand activity. The desktop client module 104 may determine which demand activity buttons are shown to a particular craftsperson based on the craftsperson's center and/or work group. The tally UI screen 308 may allow a craftsperson to keep a tally of demand activities completed by clicking the button corresponding a demand activity once for every instance of the demand activity perform. The tally UI screen 308 also may allow the craftsperson to tally multiple instances of a demand activity simultaneously. In various embodiments, a craftsperson may be a member of multiple work groups, each having its own set of demand activities. The tally UI screen 308 may, in such cases, contain one or more tabs allowing the craftsperson to access demand activities of the craftsperson's additional work groups.

The tally UI screen 308 may contain other buttons under the headings “Exception Hours” and “Lost Time.” The craftsperson may click on the “Lost Time” button to record a lost time event. Clicking on the “Lost Time” button may open a sub-window 310. The sub-window 310 may prompt the craftsperson to enter a description, duration, and classification of the lost time event. In various embodiments, lost time events may be classified into those caused by man, material, machine, measurement, and method. Additionally, lost time events may be classified as controllable or uncontrollable. The craftsperson may click the “Exception Hours” button to record an exception hours event. A description and classification of the exception hours event may be entered into a sub-window (not shown) in a way similar to that described above with reference to lost time. Classifications of exception hours and lost time may be modified by some management users, as described below.

Various embodiments may receive performance data from a craftsperson by a method other than that described above with reference to tally UI screen 308. For example, the desktop client module 104 may provide an icon on the desktop of an access device 114, such as icon 306. Right clicking on the icon 306 may cause a menu (not shown) to appear displaying demand activities. The craftsperson may tally the completion of a demand activity by selecting the particular demand activity from the menu.

Referring again to FIG. 1, data entered by craftspeople through the desktop client module 104, including centers, schedules, work groups and job performance data, may be stored in the database 116. According to various embodiments, a craftsperson may edit data stored in the database 116. In one implementation, the editing is performed by the craftsperson who entered that data on the day that the data was entered through the desktop client module 104. Additionally, other modules of the system 102 may edit, analyze and/or supplement data entered through the desktop client module 104 to track employee job performance.

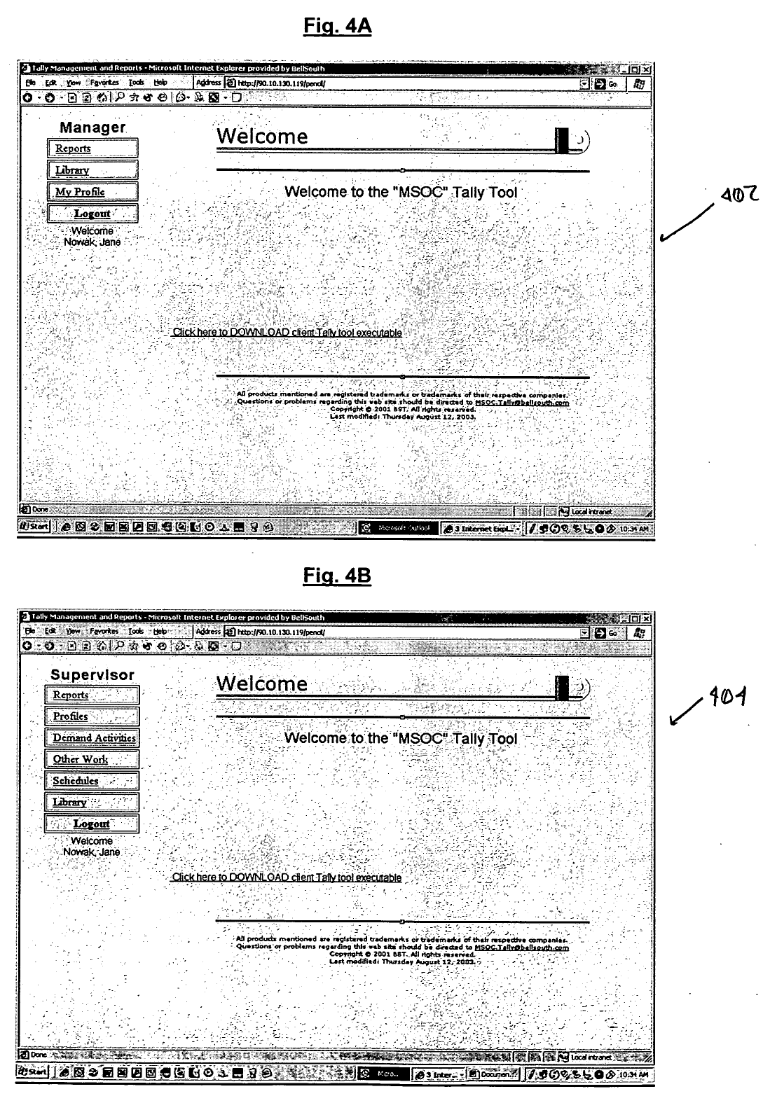

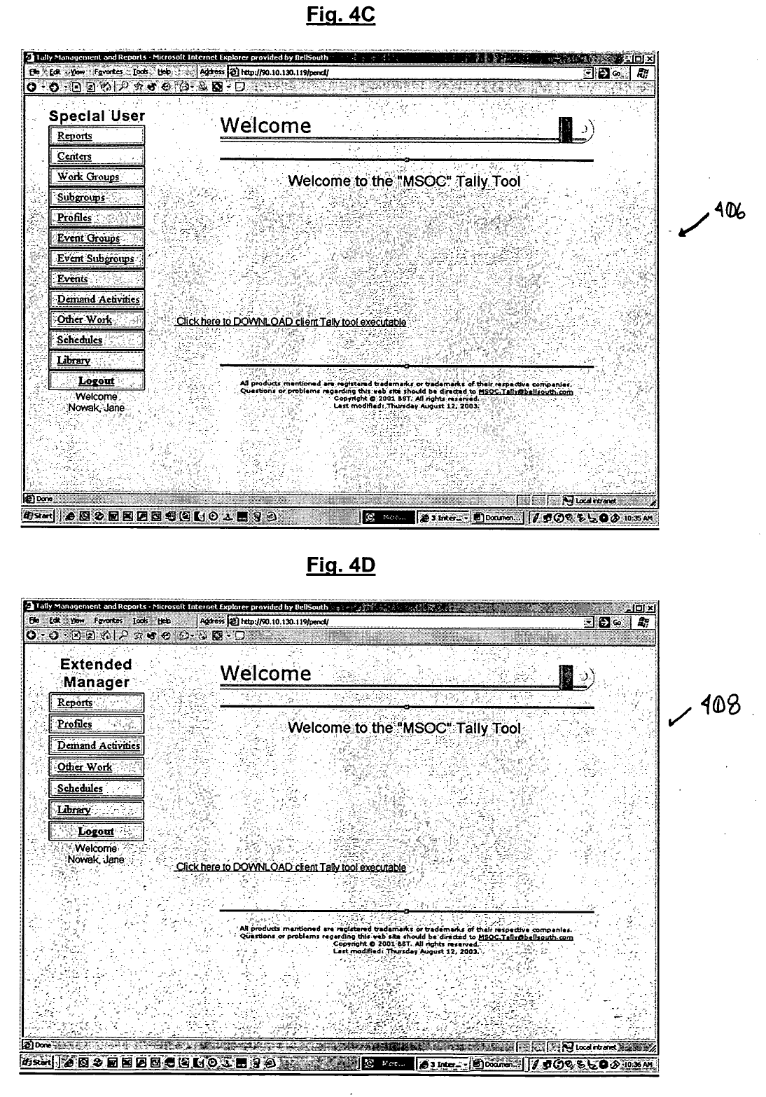

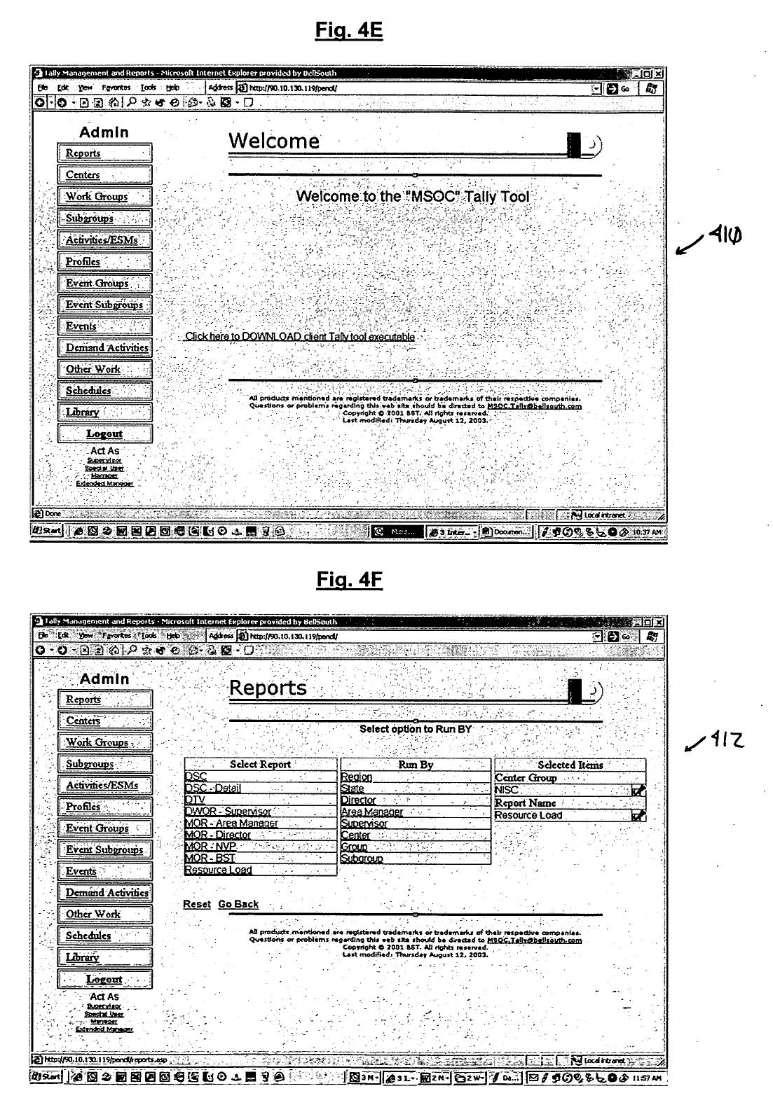

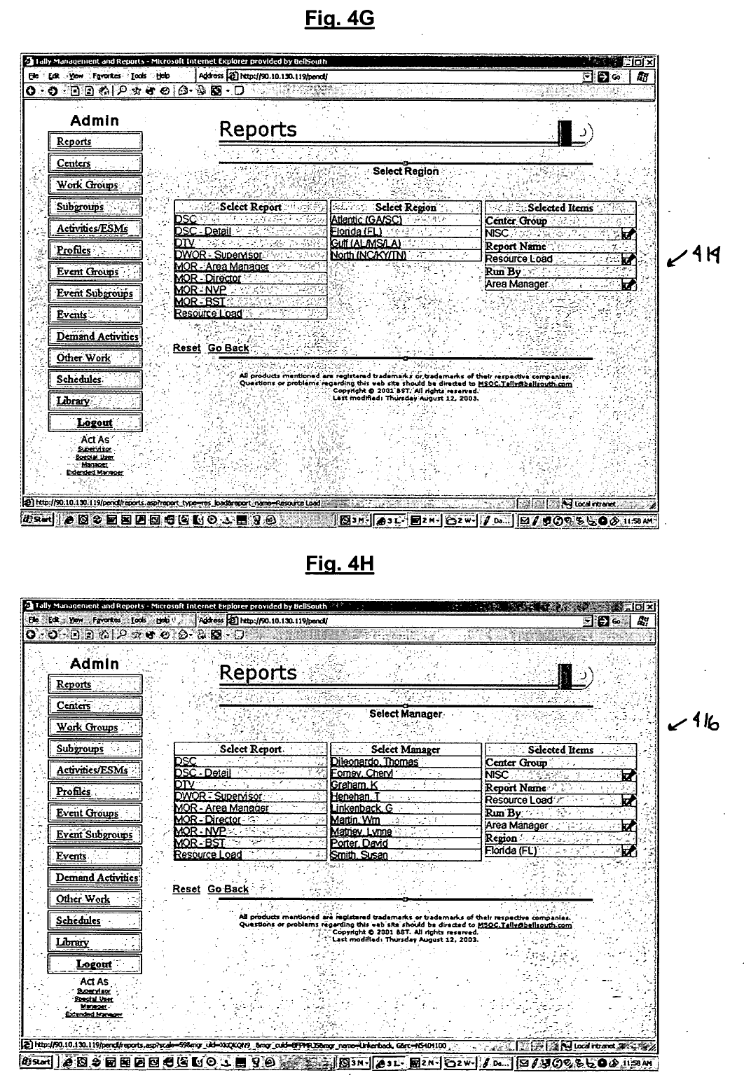

According to various embodiments, management users may access the system 102 primarily through the management module 104. The management module 104 may allow management users to edit and/or update data entered by craftspeople through the desktop client module 104, edit other aspects of the system 102, enter additional data into the database 116, and view reports of job performance, which may be prepared by the report module 110 as described further below. FIGS. 4A-4I depict UI screens 402-418 of the management module 106 according to various embodiments. A management user may access the various features of the management module 106 by selecting the feature from a menu in the various interface UI screens 402-418.

In various embodiments, different categories of management users may be given different levels of authorization to access the features of the management module 106. A table in the database 116 may be used to track the category of each management user, and the level of access given to management users in each category. Also, a management user's level of access may be determined by a user classification in a metadata directory. The categories of management users may be given access to features of the management module 106 based on the requirements of their job tasks. The level of access given to particular categories of management users may be reflected by particular UI screens 402-418 shown to management users of that category.

FIG. 4B illustrates one embodiment of a UI screen 404 that may be presented to a supervisor user according to aspects of the present invention. A supervisor user may be directly responsible for the supervision of one or more craftspeople. The supervisor user may be authorized to use the management module 106 to view reports, and edit craftsperson profiles, schedules and demand activities.

FIG. 4A illustrates one embodiment of a UI screen 402 that may be shown to an area manager user according to aspects of the present invention. An area manager user may be the direct superior of one or more supervisor users. The area manager user may be authorized to access to reports, as shown in UI screen 402. In various embodiments, a manager user may be an extended manager user and be given authorization similar to that of a supervisor user. Extended manager users may be shown a UI screen 408, depicted in FIG. 4D.

FIGS. 4C and 4E illustrate UI screens 406 and 410 that may be shown to special users and administrator users according to various embodiments. Special users and administrator users may be given authorization to access to all of the functions of the management module 106 as shown in UI screens 406 and 410.

In one implementation, the management module 106 may include a feature to allow authorized management users of the system 102 to edit data that has been entered into the database 116 by craftspeople through the desktop client module 104. As described above, a craftsperson may edit data entered through the desktop client module 104 only on the day that the data is entered. The management module 106, however, may allow a management user to edit older data by, for example, selecting one of the “Activities/ESM's,” “Demand Activities” or “Schedules” menu entries from interface UI screens 402-410. For example, a craftsperson may make a change in his or her schedule for a shift, but not record the change through the desktop client module 104 on the day of the shift. In that case, a management user, for example the craftsperson's supervisor user, may edit the craftsperson's schedule for the shift at a later time. When necessary, a management user may make similar changes to a craftsperson's tally of demand activities, exception hours, and lost time.

The management module 106 also may allow an authorized management user to edit other aspects of the system 102 including, for example, the profiles of particular craftspeople, the make-up and properties of centers or work groups, and the classification of exception hour and lost time events. A management user may edit the profile of a craftsperson by, for example, selecting the “Profiles” menu entry in UI screens 402-410. A craftsperson's profile may include his or her work group, center, and the demand activities available to be performed by the craftsperson. A management user may modify centers or work groups by, for example, selecting one of the “Centers,” “Work groups” or “Subgroups” menu entry in UI screens 402-410. The management user may modify the make up and function of existing centers and work groups, or create new centers and work groups. The management user may modify exception hours and lost time by, for example, selecting one of the “Event Groups,” “Event Subgroups” or “Events” menu entries in UI screens 402-410. The management user may be able to modify the description and classification of existing exception hours and lost time events and/or create and classify new events.

In addition to editing existing data and structure, authorized management users may use the management module 106 to enter additional information into the database 116. Some measures of employee job performance may require data other than the schedules and tallies of demand activities entered by craftspeople. Management users may use the management module 106 to enter this data by, for example, selecting an appropriate menu entry from UI screens 402-410. For example, a management user may enter a forecast of the number of instances of a particular demand activity expected in a particular center or work group.

The management module 106 also may allow authorized management users to select and access reports of employee job performance by selecting the “Reports” menu entry from UI screens 402-410. The reports may be generated by the report module 110 described below. In various embodiments, a management user may select parameters for the reports, such as for example: the type of the reports, the managerial scope of the reports, the region on which the reports will focus, and the time period of the reports.

FIGS. 4F-4I depict UI screens 412-416 for selecting parameters of reports that may be shown to a management user according to various embodiments. In UI screen 412, shown in FIG. 4F, a management user may select the report to be run and its managerial scope. In UI screen 414, shown in FIG. 4G, a management user may select the region over which the report will be run. Selections already made may be listed under the column entitled “Selected Items.” For example, the UI screen 414 indicates that a management user has selected the “Resource Load” report to be run over the managerial scope of an area manager. The particular area manager may be selected at UI screen 416 shown in FIG. 4H. Additionally, the time period of the report may be selected through UI screen 418 shown in FIG. 41.

The data analysis module 108 of the system 102 may analyze data entered through the desktop client module 104 and the management module 106 and calculate a set of statistics related to employee performance. Statistics calculated by the data analysis module 108 may be stored in the database 116 where they may be accessible to other modules 104, 106, 110 of the system 102. The data analysis module may calculate statistics over a range of managerial scopes, for example, by craftsperson, by work group, or by supervisor, and may do so over a range of time periods, including, for example, two hour intervals, complete shifts, and weeks. Examples of particular statistics that may be calculated by the data analysis module 108 are described below.

The data analysis module 108 may calculate the total hours worked by each craftsperson. The total hours worked by a craftsperson may be found by determining the number of hours in a schedule, as entered through the desktop client module 104 and potentially edited through the management module 106. The total hours worked by a particular center, work group, or other unit may be found by summing the total hours worked by all of the craftspeople in a particular unit.

The data analysis module 108 also may calculate the earned hours by each craftsperson. Earned hours may represent the amount of time that it should have taken the craftsperson to complete the demand activities that the craftsperson has tallied. For example, each kind of demand activity may be assigned a unit of time, or Engineered Service Measure (ESM), representing how long is should take a craftsperson to perform one instance of the demand activity. A craftsperson may be given credit for one of the time unit or ESM for every instance of the demand activity completed. In other words, earned hours for a particular demand activity may be found by multiplying the number of tallies for that demand activity by the ESM. The total earned hours for a work group or other unit may be found by summing the earned hours for each craftsperson in the unit.

Demand hours may represent the actual amount of time spent in productive work, or the actual amount of time that a craftsperson spends performing demand activities. The data analysis module 108 may calculate demand hours by subtracting lost time and exception hours from total time worked. The demand hours for a work group or other unit may be found by summing the demand hours of each craftsperson in the unit.

An over/under statistic may represent a measure of the average time it takes a craftsperson to perform a demand activity relative to the demand activity's ESM. The data analysis module may find an over/under statistic by subtracting earned hours from demand hours. A positive over/under may indicate that the craftsperson is taking, on average, longer to complete demand activities than the activities' ESM. A negative over/under may indicate that the craftsperson is, on average, completing demand activities in less time than the activities' ESM. Over/under measurements may also be taken for a work group, or other unit, by taking the difference between the total earned hours and the total demand hours for the unit.

Various other statistics may be calculated by the data analysis module 108. For example, productivity may be found by taking earned hours over total hours worked. Performance efficiency may be found by taking earned hours over demand hours. Utilization may be found by dividing demand hours by total hours worked. Attainment may be found by taking demand hours over planned hours. In various embodiments, planned hours may be based on forecasts entered by management users through the management module 106. It will be appreciated that the data analysis module 108 may be used to calculate various other statistics relating to employee performance in addition to those discussed above.

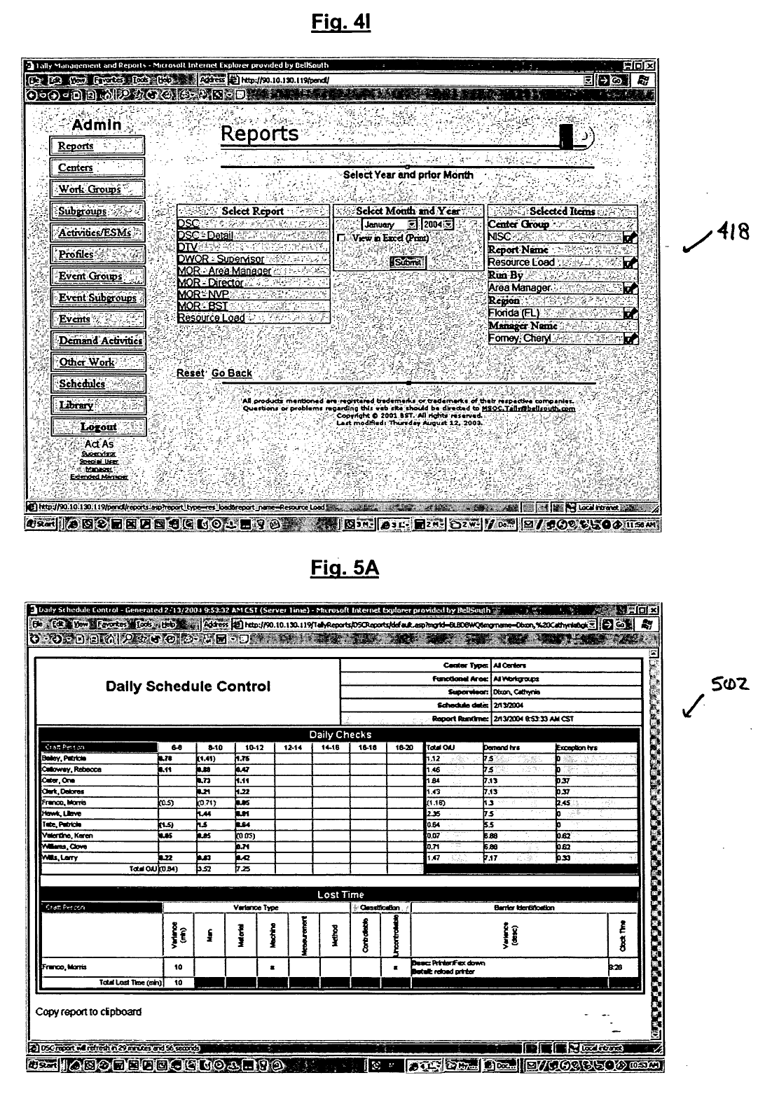

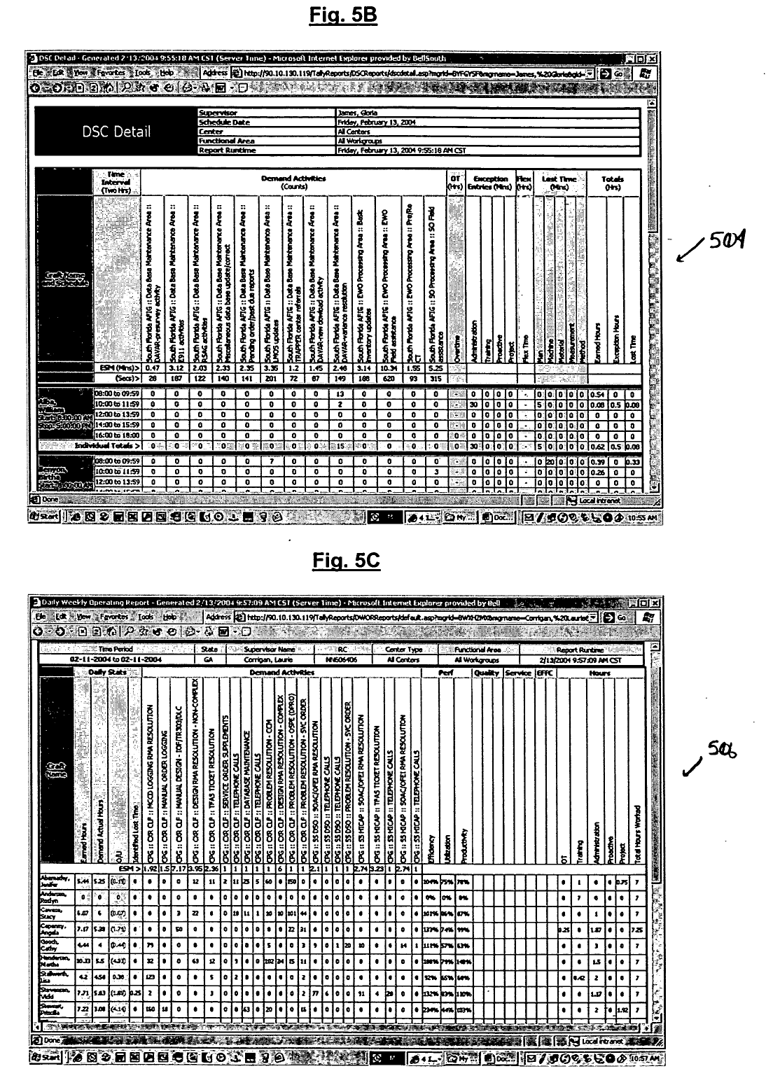

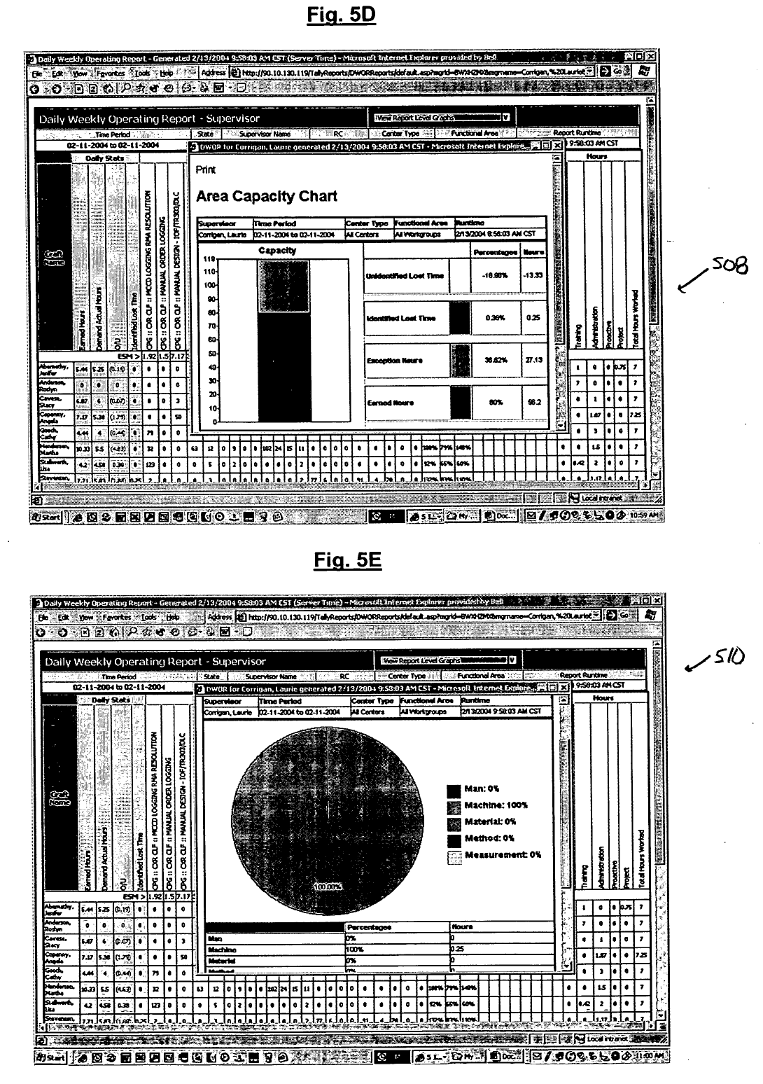

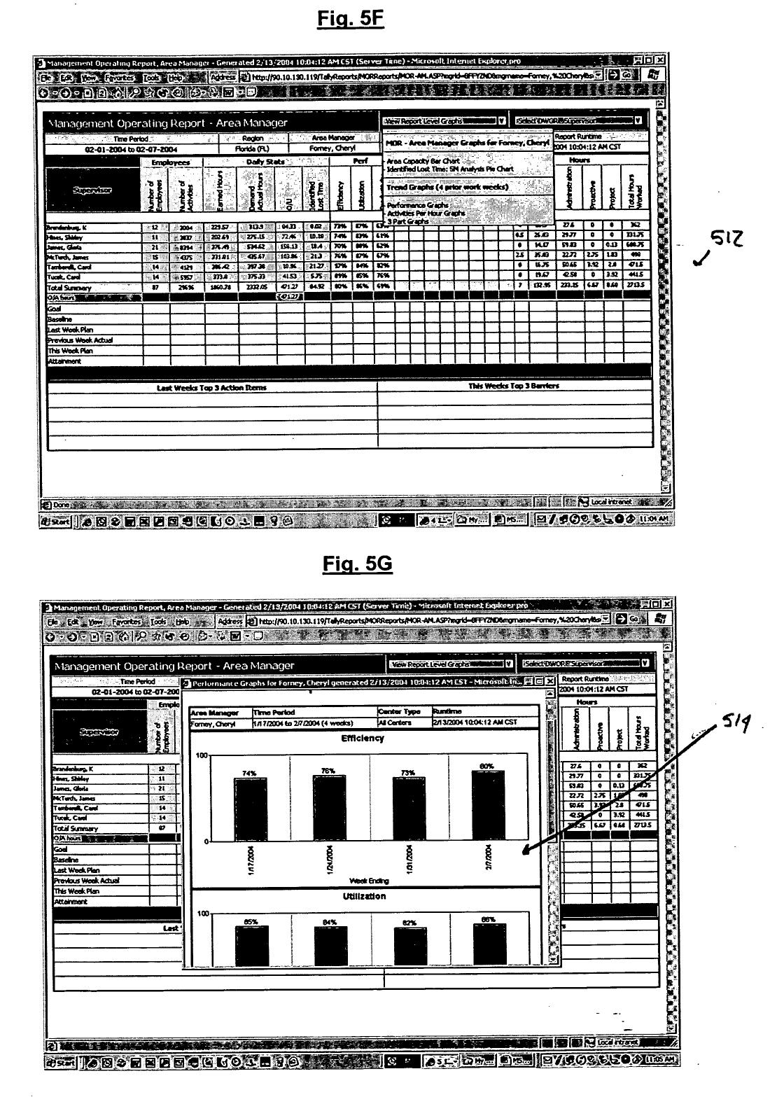

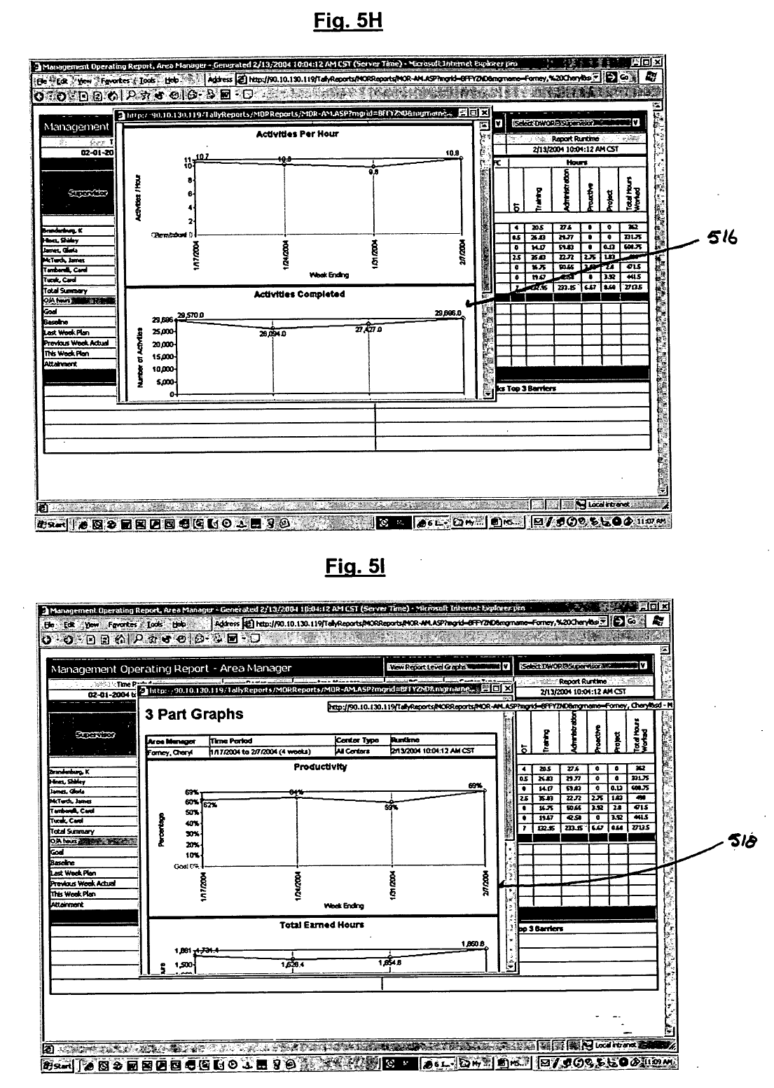

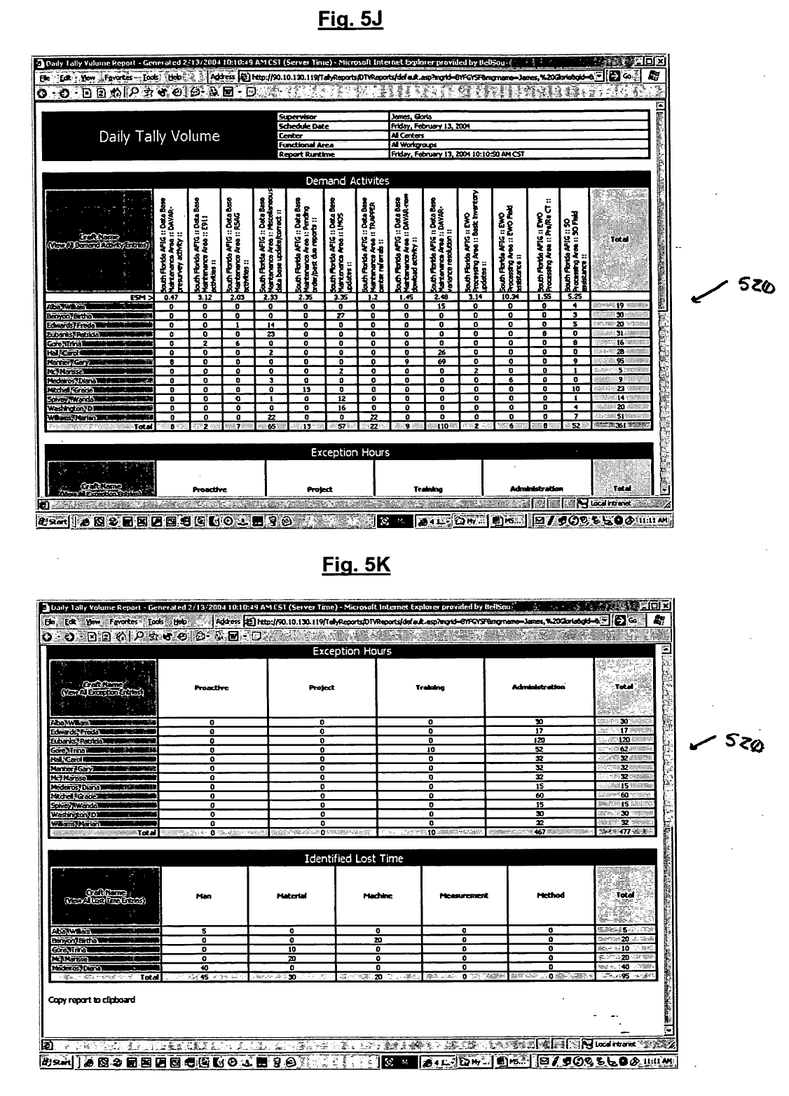

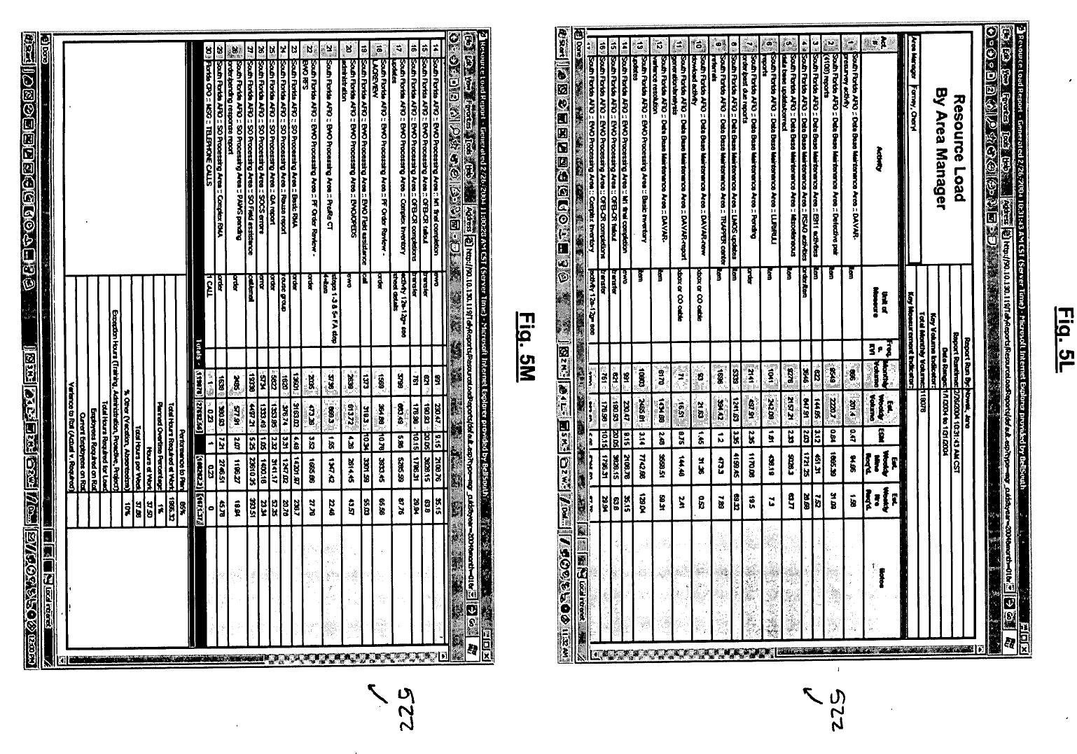

According to various embodiments, the report module 10 of the system 102 may prepare reports detailing aspects of employee job performance. The reports may be prepared from data entered into the database 116 through the desktop client module 104, the management module 106, and the data analysis module 108. The reports may be accessible to users of the system 102 through the management module 106, as discussed above. In various embodiments, the reports may be produced in real-time and based on data entered into the database 116 as of a time shortly before the report was ordered. Various reports may be generated for various purposes as described below in conjunction with FIGS. 5A-5M.

According to various embodiments, the report module 100 may generate reports over a series of managerial scopes. For example, a report may be run at the supervisor scope and list information on all craftspeople who report to a particular supervisor user. In one embodiment, a management user viewing a report at a broad scope may drill down the report to a more narrow scope. For example, a report run at the director level may be list the names and statistics of all area manager users who report to the particular director, and may be drilled down to the area manager level by selecting one of the area manager users listed in the report.

FIG. 5A shows a UI screen 502 displaying a Daily Schedule Control (DSC) report according to various embodiments. A DSC report may be typically run over the scope of a supervisor user, and contain statistics relating to all of the craftspeople under the particular supervisor user. A DSC report may typically be run to span one craftsperson shift. The supervisor user's name, and the date when the report is run may be included in the DSC report, as illustrated in UI screen 502. Under the heading “Daily Checks,” the DSC report may contain a set of job performance related statistics for each craftsperson. UI screen 502 shows one statistic, over/under, over a series of two hour intervals making up the shift. UI screen 502 also shows a summary section containing each craftsperson's total over/under, demand hours, and exception hours for the shift. In various embodiments, placing a cursor over a craftsperson's particular statistic may show additional information, including, for example, a listing of all demand activities performed by the craftsperson, a number of each demand activity performed by the craftsperson, and the craftsperson's schedule.

A DSC report may also show lost time, listed separately under the heading “Lost Time” as shown in UI screen 502. For each lost time event, the DSC report may show the duration of the event, a cause of the event, a classification of the event, and a description of the event. For example, in various embodiments, events may be caused by man, material, machine, measurement, or method and may be classified as controllable or uncontrollable.

The DSC report may be used by a supervisor user to monitor the job performance of craftspeople in real time, and address potential barriers to performance as they occur. The supervisor user may, according to various embodiments, use the system 102 to generate a DSC report at two hour intervals, though real-time reports may be created at any interval. The DSC report may indicate a barrier to productivity when a craftsperson has an over/under that is significantly above one, or a significant amount of lost time. Additionally, comparing the over/under statistics of various craftspeople over a series of two hour intervals may allow a supervisor user to detect changes that may also indicate a barrier to productivity. By alerting a supervisor user to potential barriers to craftsperson productivity, the DSC report may allow the supervisor user to address barriers at an early stage, thereby minimizing their duration and effect.

FIG. 5B shows a UI screen 504 displaying a Daily Schedule Control Detail (DSC Detail) report according to various embodiments. Like the DSC report, the DSC Detail report may typically be run over the scope of a supervisor user, may contain job performance statistics relating to craftspeople under the supervision of the supervisor user, and may also be used by the supervisor user to address potential barriers to productivity as they occur. The DSC Detail report, however, may contain more statistics than the DSC report. For example, the DSC Detail report may break out the number and type of demand activities performed by each craftsperson, and may list each craftsperson's schedule. In addition, rather than listing each craftsperson's over/under statistics, the DSC Detail report may report the actual tallies of each demand activity entered, the ESM for the demand activity and the earned hours, as shown in UI screen 504. Like the DSC report, the DSC Detail report may provide statistics relating to one craftsperson shift.

FIGS. 5C-5E show UI screens 506-510 displaying various portions of a Daily Weekly Operating Report (DWOR) according to various embodiments. Like the DSC report and the DSC detail report, the DWOR report may typically be run over the scope of a supervisor, and may list statistics relating to all of the craftspeople under the supervision of a particular supervisor user. Unlike those reports, though, the statistics in the DWOR report may be calculated over the period of a day or a week. Statistics included in the DWOR report for each craftsperson may include earned hours, demand hours, over/under and lost time. Also, the DWOR report may list every instance of each demand activity performed by each craftsperson. Performance statistics such as efficiency, utilization, and productivity may be included, as well as time spent under particular categories including overtime, training, administrative, and total time worked. In some embodiments, the DWOR report may also list service and quality statistics for each craftsperson. Service and quality statistics may include, for example, the number of errors committed by the craftsperson, and may be established by individual centers.

In addition to the chart shown in UI screen 506, the DWOR report also may display a series of graphs. An “Area Capacity Chart,” shown as UI screen 508 in FIG. 5D, may display the total disposition of time over the day or week by the craftspeople under the supervisor user. For example, the “Area Capacity Chart” may show what percentage of time spent comprises earned hours, what percentage comprises exception hours, and what percentage comprises lost time. A Lost Time Chart, shown as UI screen 510 in FIG. 5E may display the percentage of reported lost time attributable to each category.

The DWOR and its charts may be used to identify trends in key indicators of employee performance. By identifying and addressing trends on a daily and a weekly basis, it may be possible to address potential performance issues early, minimizing their negative impact. It may also be possible to identify particularly effective management and demand activity techniques at an early stage, increasing their positive impact.

FIGS. 5F-5I show UI screens 512-518 displaying portions of a Management Operating Report (MOR) according to various embodiments. An MOR report, unlike a DSC report or a DWOR report, typically may be run over the scope of an area manager, and may list job performance statistics for all of the supervisor users who report directly to one area manager user. Job performance statistics for supervisor users may include summaries of the job performance statistics of the craftspeople for whom the supervisor user is responsible.

Referring to the UI screen 512, an MOR report may break supervisor statistics into the categories of “Employees,” “Daily Stats,” “Performance,” “Quality and Service” and “Hours.” Statistics listed under “Employees” may include the total number of craftspeople who report to each supervisor user, and the total number of activities performed by those craftspeople over the period of the report. Statistics listed under “Daily Stats” may include the total earned hours, demand hours, over/under, and identified lost time recorded by the supervisor user's craftspeople over the period of the report. Performance statistics may include efficiency, utilization, and productivity. The MOR report also may contain fields for showing performance goals, improvements, and attainment.

Like a DWOR report, an MOR report also may display a series of graphs. For example, a performance graph, shown as UI screen 514 in FIG. 5G, may visualize and show trends in daily and weekly performance statistics. Another graph, shown as UI screen 516 in FIG. 5H may show trends in activities per hour and total activities completed. Yet another graph, shown as UI screen 518 in FIG. 5I, may show trends in productivity and total earned hours.

Like the DWOR report, the MOR report and its charts may be used to identify trends in key indicators of employee performance. Unlike the DWOR report, however, the MOR report may help identify trends at a supervisor user level rather than the craftsperson level focused on by the DWOR report and DSC. By identifying the strengths and weakness of particular supervisor users, an organization implementing the system 102 may be able to minimize weaknesses and increase strengths.

FIGS. 5J-5K show a UI screen 520 displaying portions of a Daily Tally Volume Report (DTVR) according to various embodiments. Like the DCS and DWOR reports, the DTVR report may typically be run over the scope of a supervisor user and may contain statistics relating to all of the craftspeople who work under the supervisor user. Under “Demand Activities,” the DTVR may show the number of tally strokes entered by each craftsperson under each demand activity. Also, under “Exception Hours” and “Identified Lost Time,” the DTVR may show the exception hours and lost time listed by each employee over the course of a shift. A supervisor user may utilize a DTVR, for example, at the end of a shift to look for possible anomalies or errors in data entry. For example, a craftsperson may mistakenly enter too many tallies under a given demand activity. When this occurs, the supervisor user may notice the anomaly in the DTVR report. The supervisor user may correct the error through the management module 106, as described above.

FIGS. 5L-5M show a UI screen 522 displaying a Resource Load report according to various embodiments. A Resource Load report generally may be run at the area manager level or higher, and may show various statistics related to each demand activity performed by craftspeople under the area manager user. Each demand activity may have an estimated monthly volume representing the number of times that the organization expects the demand activity to be performed over the month of the report. According to various embodiments, the estimated monthly volume may have been entered through the management module 106. Also listed may be an estimated weekly volume, estimated weekly minutes required for the demand activity, the ESM for the demand activity, and estimated weekly hours for the demand activity. An area manager user may use a Resource Load report to verify that labor resources are in place to handle expected tasks. According to various embodiments, a Resource Load report may be run once a month; however, more frequent reports may be run if there is a change in expected work volume, sales, or number of jobs.

A number of implementations have been described. Nevertheless, it will be understood that various modifications may be made and that other implementations are within the scope of the following claims.

What is claimed is:

1. A computer-implemented system of tracking employee job performance comprising:
a desktop client module for receiving performance-related data from an employee, wherein the performance-related data comprises a schedule from the employee, a number of instances of a demand activity performed by the employee, and a type of the demand activity performed by the employee;
a processing module for calculating a statistic related to job performance of the employee based on the performance-related data; and
a report module for generating a report detailing the job performance of the employee, wherein the report is generated over a managerial scope received from a management user and includes the statistic related to the job performance of the employee.

2. The system of claim 1, further comprising a management module for providing a level of access to the management user.

3. The system of claim 2, wherein the level of access provided to the management user depends on a class of the management user.

4. The system of claim 2, wherein the management module displays the report.

5. The system of claim 1, wherein the schedule from the employee includes a first starting time and a first ending time of a first shift.

6. The system of claim 5, wherein the schedule from the employee further includes a second starting time and a second ending time of a second shift.

7. The system of claim 1, wherein the schedule from the employee includes a starting time and a duration of a break.

8. The system of claim 1, wherein the desktop client module provides a list of demand activities to the employee, the list including a plurality of demand activities.

9. The system of claim 1, wherein the performance-related data includes a number of exception hours and a description of lost time.

10. The system of claim 1, wherein the processing module calculates a statistic chosen from: earned hours, demand hours, and over/under.

11. The system of claim 1, wherein the report includes service and quality statistics.

12. The system of claim 1, wherein the report includes a graphical representation of the statistic related to the job performance of the employee job performance.

13. A computer-implemented method of tracking employee job performance comprising the steps of:
receiving performance-related data from an employee, wherein the performance-related data comprises a schedule from the employee, a number of a demand activity performed by the employee, and a type of the demand activity performed by the employee;
calculating a statistic related to the job performance of the employee based on the performance-related data; and
generating a report detailing the job performance of the employee, wherein the report is generated over a managerial scope received from a management user and includes the statistic related to job performance.

14. The method of claim 13, further comprising receiving a request for the report from a management user.

15. The method of claim 13, further comprising receiving an edit to performance-related data from a management user, and wherein the management user belongs to a class of management users authorized to edit performance-related data.

16. The method of claim 13, wherein the performance-related data includes a number of exception hours and a description of lost time.

17. The method of claim 13, further comprising calculating a second statistic related to the job performance of the employee, wherein the second statistic is calculated over a different managerial scope than the statistic.

18. The method of claim 13, further comprising calculating a statistic chosen from: earned hours, demand hours, and over/under.

19. The method of claim 13, wherein the report contains a graphical representation of the statistic.

20. A computer program stored on a computer-readable medium, the program comprising instructions for:
receiving performance-related data from an employee, wherein the performance-related data comprises a schedule from the employee, a number of a demand activity performed by the employee, and a type of the demand activity performed by the employee;
calculating a statistic related to the job performance of the employee based on the performance-related data; and
generating a report detailing the job performance of the employee, wherein the report is generated over a managerial scope received from a management user and includes the statistic related to job performance.
